(19) United States
(12) Patent Application Publication
(10) Pub. No.: US 2026/0243891 A1
(43) Pub. Date: Aug. 20, 2026

(54) VEHICLE BODY STRUCTURE

(71) Applicant: HONDA MOTOR CO., LTD., Tokyo (JP)

(72) Inventor: Takato WATANABE, Tokyo (JP)

(21) Appl. No.: 19/377,356

(22) Filed: Nov. 3, 2025

(30) Foreign Application Priority Data
Feb. 19, 2025 (JP) 2025-024898

(51) Int. Cl. G01S 13/931; B60R 11/02; B60R 13/04; B62D 25/00

(52) U.S. Cl. CPC G01S 13/931; B60R 11/02; B60R 13/04; B62D 25/00; G01S 2013/93272; G01S 2013/93275; G01S 2013/93277

(57) ABSTRACT

A vehicle body structure includes: a vehicle body panel; a garnish made of resin, attached to an outer surface of the vehicle body panel, and forming an accommodating space between the garnish and the vehicle body panel; a bracket attached to the vehicle body panel in the accommodating space; a radar attached to the bracket; and a cover attached to the bracket. The cover includes an upper wall extending laterally above the sensor and extending from the bracket to the garnish. The upper wall includes, at a distal end thereof, a plate-like abutting portion having flexibility and configured to bend and come into surface contact with an inner surface of the garnish.

### TECHNICAL FIELD

The present invention relates to a vehicle body structure.

### BACKGROUND ART

In recent years, efforts have been actively made to provide sustainable transportation systems that take into account people in vulnerable situations among traffic participants. To achieve this, research and development of driving assistance technologies for further improving safety and convenience of traffic is being conducted.

Conventionally, a vehicle is provided with a sensor for detecting obstacles around the vehicle to provide driving assistance or autonomous driving. JP7285292B discloses a vehicle body structure including a vehicle body panel, a bumper face covering an outer surface of the vehicle body panel, and a sensor arranged between the vehicle body panel and the bumper face. The sensor transmits and receives radio waves through the bumper face. A lower portion and lateral sides of the sensor are covered by a cover. The cover prevents rainwater, muddy water, dust, and other foreign matters that are splashed up from a road surface and penetrating into the bumper face from adhering to the sensor.

The rainwater and other water may penetrate into an inner surface side of a garnish through a gap between an upper edge of the garnish, such as the bumper face, and an outer surface of the vehicle body panel, and then flow downward along the inner surface of the garnish. When the water adheres to the inner surface of the garnish in front of the sensor, a detection accuracy of the sensor may decrease.

### SUMMARY OF THE INVENTION

In view of the above background, an object of the present invention is to prevent water from adhering to an inner surface of a garnish in front of a sensor in a vehicle body structure.

To achieve such an object, one aspect of the present invention provides a vehicle body structure, including: a vehicle body panel; a garnish made of resin, attached to an outer surface of the vehicle body panel, and forming an accommodating space between the garnish and the vehicle body panel; a bracket attached to the vehicle body panel in the accommodating space; a sensor attached to the bracket; and a cover attached to the bracket. The cover includes an upper wall extending laterally above the sensor and extending from the bracket to the garnish, and the upper wall includes, at a distal end thereof, a plate-like abutting portion having flexibility and configured to bend and come into surface contact with an inner surface of the garnish.

Thus, according to the above aspects, it is possible to prevent water from adhering to the inner surface of the garnish in front of the sensor in the vehicle body structure.

### BRIEF DESCRIPTION OF THE DRAWING(S)

FIG. 1 is a perspective view of a vehicle including a vehicle body structure according to a present embodiment;

FIG. 2 is a side view of the vehicle body structure;

FIG. 3 is a cross-sectional view of the vehicle body structure; and

FIG. 4 is a side view of the vehicle body structure with a garnish omitted.

### DETAILED DESCRIPTION OF THE INVENTION

In the following, an embodiment of a vehicle body structure 5 will be described with reference to the drawings.

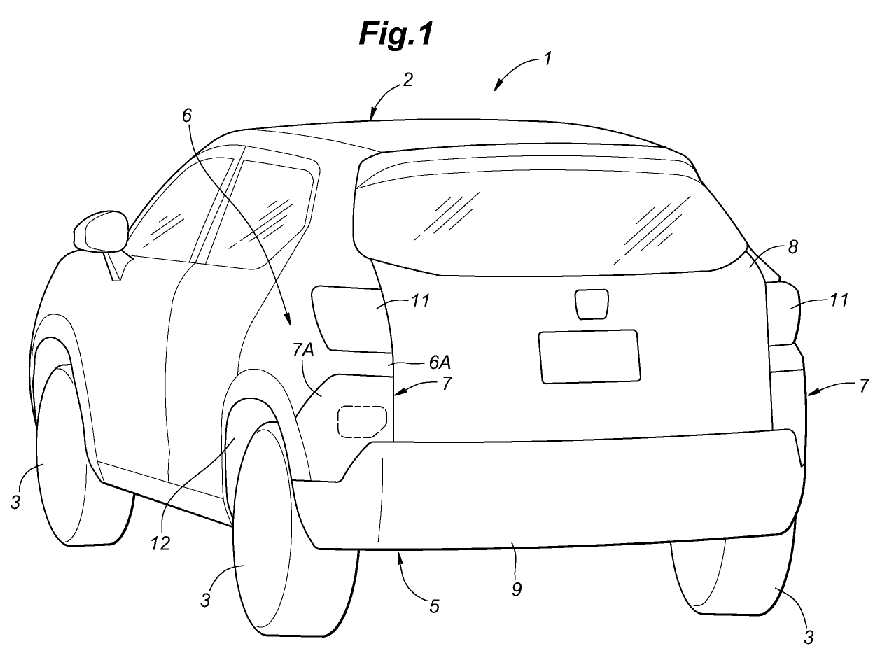

As shown in FIG. 1, a vehicle 1 is a four-wheeled automobile including a vehicle body 2 and wheels 3. The vehicle body structure 5 that constitutes the rear portion of the vehicle body 2 includes a vehicle body panel 6, and a garnish 7 made of resin and attached to the outer surface of the vehicle body panel 6. The vehicle body structure 5 also includes a tailgate 8, a rear bumper face 9, and a taillight 11 attached to the vehicle body panel 6.

The vehicle body panel 6 is a plate-like member that forms the outer surface of the vehicle 1. In the present embodiment, the vehicle body panel 6 constitutes wheelhouses 12 of the rear wheels 3, and the outer surface of the rear portion of the vehicle 1. The vehicle body panel 6 according to the present embodiment is also referred to as a rear side outer panel. The vehicle body panel 6 is formed by press-forming a steel plate. The vehicle body panel 6 may be formed from a single member, or may be formed by combining a plurality of members.

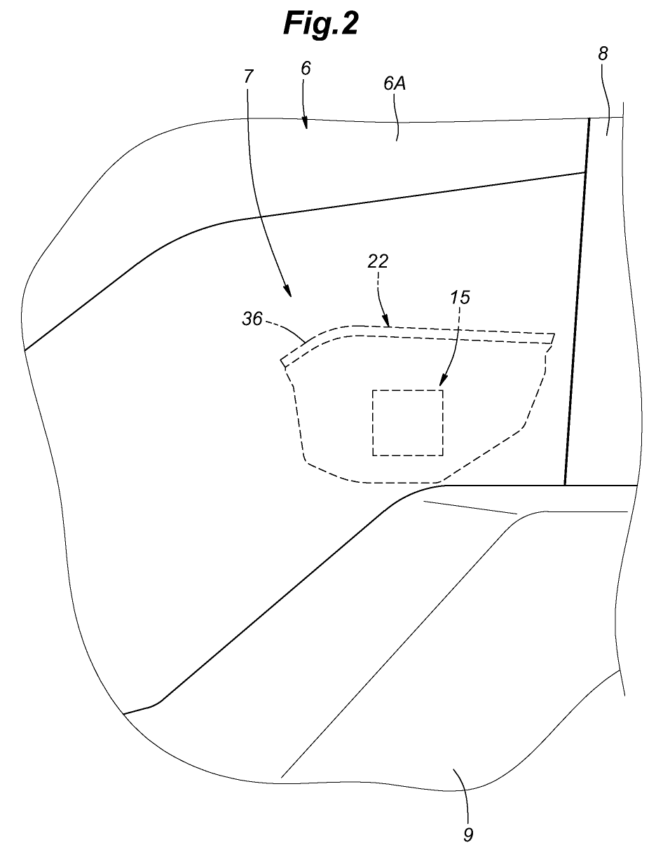

As shown in FIGS. 1 and 2, the garnish 7 is arranged on the outer surface of the vehicle body panel 6 and forms the outer surface of the vehicle 1. The garnish 7 is arranged at the corner of the rear portion of the vehicle 1. The garnish 7 forms an accommodating space 13 between the garnish 7 and the vehicle body panel 6. A radar 15 is arranged in the accommodating space 13 as a sensor. When the sensor is the radar 15, the garnish 7 is made of a resin material that transmits radio waves.

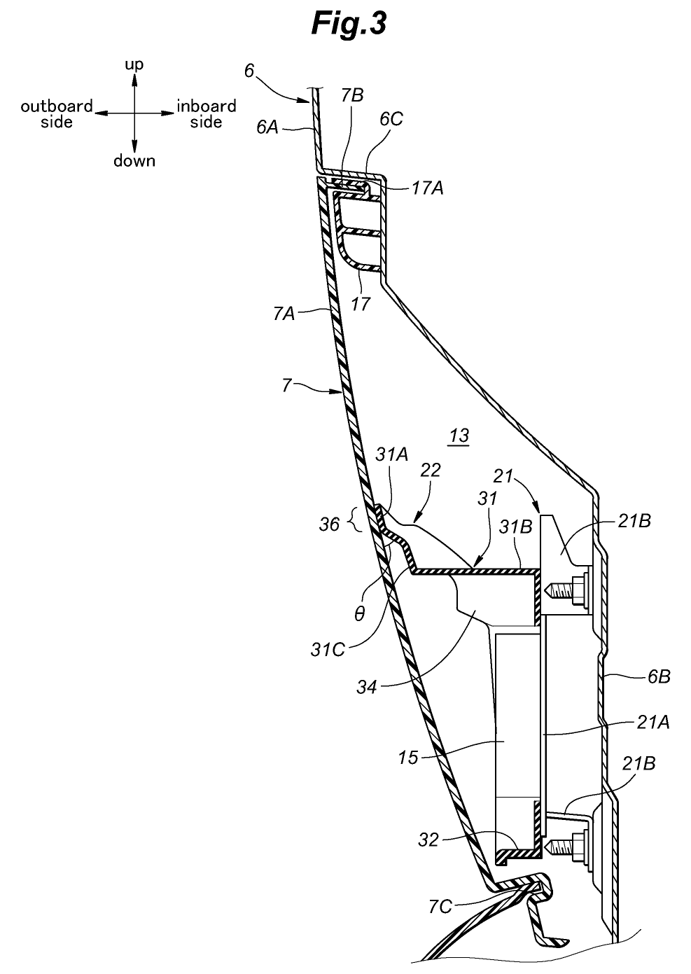

As shown in FIG. 3, the vehicle body panel 6 includes an outer wall 6A that forms the outer surface of the vehicle 1, an inner wall 6B that is offset toward the inboard side relative to the lower end of the outer wall 6A in a stepped manner, and a connecting wall 6C that connects the lower end of the outer wall 6A and the upper end of the inner wall 6B. The outer wall 6A extends vertically and is exposed to the outside of the vehicle 1. The inner wall 6B extends vertically and is covered by the garnish 7. The connecting wall 6C faces downward and extends along the lower edge of the outer wall 6A and the upper edge of the inner wall 6B. The connecting wall 6C is arranged perpendicular to the outer wall 6A and the inner wall 6B.

The garnish 7 includes a plate-shaped portion 7A that is inclined downward toward the vehicle body panel 6. The garnish 7 includes an upper edge wall 7B provided along the upper edge of the plate-shaped portion 7A and arranged along the connecting wall 6C. The upper edge wall 7B protrudes from the upper edge of the plate-shaped portion 7A toward the inboard side in a substantially horizontal direction.

The upper end of the inner wall 6B is provided with a retainer 17 that locks the upper edge wall 7B. The retainer 17 extends along the upper end of the inner wall 6B. The retainer 17 is preferably made of a resin material. The retainer 17 includes a plurality of locking portions 17A that receive and lock the upper edge wall 7B. A plurality of locking holes may be formed in the upper edge wall 7B so that the plurality of locking portions 17A of the retainer 17 are hooked therein. The garnish 7 is coupled to the vehicle body panel 6 by the retainer 17. When the garnish 7 is coupled to the vehicle body panel 6, the upper edge of the plate-shaped portion 7A of the garnish 7 is arranged along the lower edge of the outer wall 6A of the vehicle body panel 6. The outer surface of the outer wall 6A and the outer surface of the plate-shaped portion 7A may be arranged so as to be flush with each other.

The lower end of the garnish 7 is arranged close to the outer surface of the inner wall 6B. The lower end of the garnish 7 may abut against the outer surface of the inner wall 6B. An engagement groove 7C, which is recessed toward the vehicle body panel 6 is formed on the outer surface of the lower end of the garnish 7. The upper edge of the rear bumper face 9 protrudes into the engagement groove 7C. Accordingly, the relative positions of the garnish 7 and the rear bumper face 9 are fixed.

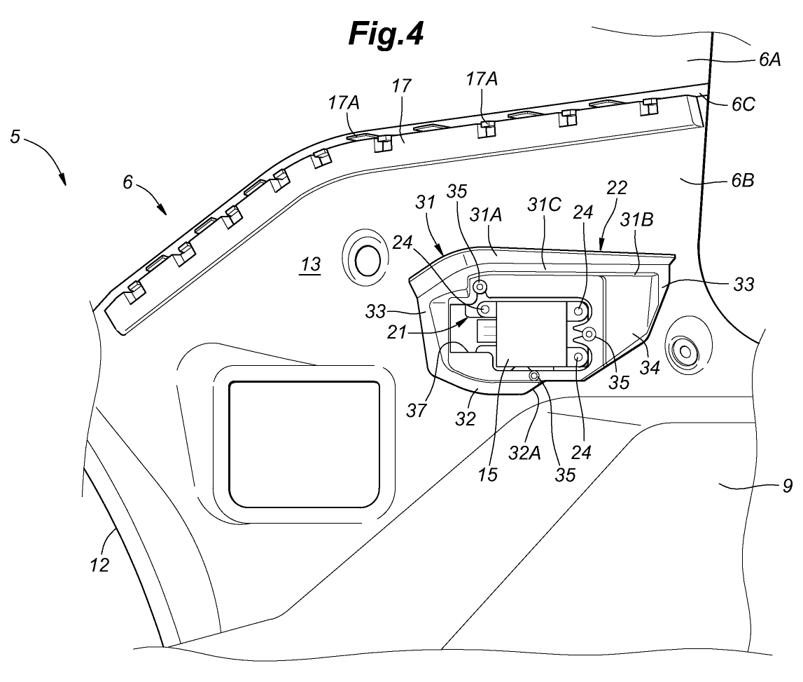

As shown in FIGS. 3 and 4, the vehicle body structure 5 includes a bracket 21 attached to the vehicle body panel 6 in the accommodating space 13, the radar 15 attached to the bracket 21, and a cover 22 attached to the bracket 21.

The bracket 21 is provided on the outer surface of the inner wall 6B of the vehicle body panel 6. The bracket 21 includes a support portion 21A arranged on the outboard side of the inner wall 6B with a gap therebetween, and a plurality of leg portions 21B extending from the support portion 21A to the inner wall 6B and fastened to the inner wall 6B. The support portion 21A may be formed in a plate-like shape. The bracket 21 is preferably made of a steel plate. The main surface of the support portion 21A faces the outboard side.

The radar 15 may be, for example, a millimeter wave radar. The radar 15 may be formed, for example, in a flat rectangular parallelepiped shape. The radar 15 may be coupled to the outer surface of the support portion 21A of the bracket 21 by a fastener 24, such as a screw. A gap is formed between the radar 15 and the inner surface of the garnish 7. The radar 15 transmits radio waves to the outboard side, that is, toward the garnish 7. In the present embodiment, the radar 15 transmits radio waves rearward and laterally from the corners of the rear portion of the vehicle 1.

As shown in FIGS. 3 and 4, the cover 22 includes at least an upper wall 31. The upper wall 31 extends laterally above the radar 15 and extends from the bracket 21 to the garnish 7. In the present embodiment, the cover 22 includes a lower wall 32 extending from the bracket 21 to the garnish 7 below the radar 15, and a pair of vertical walls 33 extending from the bracket 21 to the garnish 7 on the lateral sides of the radar 15. The upper end of each of the vertical walls 33 is connected to the upper wall 31, and the lower end of each of the vertical walls 33 is connected to the lower wall 32. That is, the cover 22 is formed in a tubular shape so as to surround the radar 15.

The cover 22 includes a bottom wall 34 coupled to the outer surface of the support portion 21A. The bottom wall 34 is formed in a plate-like shape and extends along the outer surface of the support portion 21A. The bottom wall 34 may be coupled to the support portion 21A by a fastener 35, such as a screw. The width of the bottom wall 34 is greater than the width of the support portion 21A. That is, the bottom wall 34 extends laterally from the support portion 21A. In the center of the bottom wall 34, an opening 37, which is a through hole for avoiding interference with the radar 15, is formed. The upper wall 31, the lower wall 32, and the left and right vertical walls 33 are provided along the edges of the bottom wall 34. As described above, the radar 15 and the cover 22 are attached to the support portion 21A.

The cover 22 is preferably formed from an olefin-based thermoplastic elastomer (TPO). The olefin-based thermoplastic elastomer preferably has a hard segment made of polyolefin such as polypropylene (PP) or polyethylene (PE), and a soft segment made of a rubber component such as ethylene-propylene rubber (EPM) or ethylene-propylene-diene rubber (EPDM).

The upper wall 31 includes, at a distal end thereof, a plate-like abutting portion 31A having flexibility and configured to bend and come into surface contact with the inner surface of the garnish 7. The upper wall 31 also includes a base portion 31B extending from the bracket 21 to the outboard side, and an intermediate portion 31C bending upward from the distal end of the base portion 31B. The abutting portion 31A extends from the upper end of the intermediate portion 31C to the outboard side. The thickness of the abutting portion 31A is preferably thinner than the thickness of each of the base portion 31B and the intermediate portion 31C. This allows the abutting portion 31A to have higher flexibility than the base portion 31B and the intermediate portion 31C. Further, the rigidity of the base portion 31B and the intermediate portion 31C can be improved, thereby suppressing deformation of the upper wall 31. The width of the upper wall 31 is greater than the width of the radar 15. The upper wall 31 extends laterally outward beyond the radar 15.

The abutting portion 31A is inclined upward toward the plate-shaped portion 7A. The abutting portion 31A abuts against the plate-shaped portion 7A. The distal end of the abutting portion 31A is bent upward by abutting against the inner surface of the plate-shaped portion 7A and extends along the inner surface of the plate-shaped portion 7A. As shown in FIG. 3, the angle θ between the plate-shaped portion 7A and the abutting portion 31A is preferably 30 degrees or more and 60 degrees or less. This allows the abutting portion 31A of the upper wall 31 to come into surface contact with the plate-shaped portion 7A of the garnish 7 smoothly. An area 36 where the abutting portion 31A and the plate-shaped portion 7A are in surface contact extends in the lateral direction. The area 36 where the abutting portion 31A and the plate-shaped portion 7A are in surface contact extends laterally above the radar 15.

A gap is formed between the lower wall 32 and the plate-shaped portion 7A. The lower wall 32 may have a notch 32A formed in the center thereof, the notch 32A being recessed toward the inboard side and penetrating in the up-and-down direction. Accordingly, it is possible to prevent water from accumulating on the upper surface of the lower wall 32. A gap is also formed between the pair of vertical walls 33 and the plate-shaped portion 7A. The length of each vertical wall 33 toward the plate-shaped portion 7A decreases toward the lower side.

According to the vehicle body structure 5 described above, even when water penetrates into the accommodating space 13 through the gap between the upper edge of the garnish 7 and the vehicle body panel 6 and flows along the inner surface of the plate-shaped portion 7A, the water flows along the upper surface of the upper wall 31 toward the vehicle body panel 6 because the upper wall 31 abuts against the plate-shaped portion 7A. The water then flows downward from behind the radar 15 and the support portion 21A of the bracket 21, and therefore, adhesion of water to the inner surface of the plate-shaped portion 7A in front of the sensor is suppressed. This suppresses a decrease in the detection accuracy of the radar 15.

When an object collides with the garnish 7 from the outside and the garnish 7 moves toward the vehicle body panel 6, the abutting portion 31A deforms, thereby suppressing the bracket 21 from being pressed against the cover 22. This suppresses deformation and displacement of the bracket 21, and also suppresses displacement of the radar 15.

The embodiment is not limited to the above configuration and can be widely modified and implemented. For example, the sensor may be another obstacle detection sensor such as a light detection and ranging (LiDAR) instead of the radar 15. When the sensor is a LiDAR, the garnish 7 is preferably made of a material that transmits the light emitted by the LiDAR.

Further, the sensor may be a camera instead of the radar 15. When the sensor is a camera, the garnish 7 is preferably made of a material that transmits visible light.

The sensor including the radar 15 may be provided at the corner of the front portion of the vehicle 1 instead of at the corner of the rear portion of the vehicle 1. Further, the sensor including the radar 15 may be provided at the front end or the rear end of the vehicle body 2 to detect the obstacle in front of or behind the vehicle 1.

In another embodiment, the cover 22 may include, in addition to the upper wall 31, flexible abutting portions at the distal ends of the pair of vertical walls 33. Each abutting portion of the pair of vertical walls 33 may deform and abut against the inner surface of the plate-shaped portion 7A of the garnish 7. Each abutting portion of the pair of vertical walls 33 preferably extends in directions away from each other toward the outboard side. The abutting portions of the pair of vertical walls 33 may be connected to the abutting portion 31A of the upper wall 31.

In another embodiment, the garnish 7 may form a part of other decorative elements, such as the bumper face or front grille. The garnish 7 may also form a portion of a decorative member that fills the gap between the headlight and the front bumper face.

The above embodiment may also be described as follows.

One embodiment of the present invention provides a vehicle body structure 5, including: a vehicle body panel 6; a garnish 7 made of resin, attached to an outer surface of the vehicle body panel 6, and forming an accommodating space 13 between the garnish 7 and the vehicle body panel 6; a bracket 21 attached to the vehicle body panel 6 in the accommodating space 13; a sensor (a radar 15) attached to the bracket 21; and a cover 22 attached to the bracket 21. The cover 22 includes an upper wall 31 extending laterally above the sensor (the radar 15) and extending from the bracket 21 to the garnish 7, and the upper wall 31 includes, at a distal end thereof, a plate-like abutting portion 31A having flexibility and configured to bend and come into surface contact with an inner surface of the garnish 7.

According to this aspect, water flowing downward along the inner surface of the garnish 7 is blocked by the upper wall 31, thereby preventing penetration of the water into the area in front of the sensor (the radar 15). Accordingly, it is possible to prevent water from adhering to the inner surface of the garnish 7 in front of the sensor (the radar 15) in the vehicle body structure 5.

In the above embodiment, preferably, the garnish 7 includes a plate-shaped portion 7A that is inclined downward toward the vehicle body panel 6, and the abutting portion 31A is inclined upward toward the plate-shaped portion 7A and abuts against the plate-shaped portion 7A.

According to this aspect, the abutting portion 31A of the upper wall 31 can come into surface contact with the plate-shaped portion 7A of the garnish 7 smoothly.

In the above embodiment, preferably, an angle between the plate-shaped portion 7A and the abutting portion 31A is 30 degrees or more and 60 degrees or less.

According to this aspect, the abutting portion 31A of the upper wall 31 can come into surface contact with the plate-shaped portion 7A of the garnish 7 smoothly.

In the above embodiment, preferably, the cover 22 is made of an olefin-based thermoplastic elastomer.

According to this aspect, the abutting portion 31A can be made flexible.

In the above embodiment, preferably, the vehicle body panel 6 includes an outer wall 6A that forms an outer surface of a vehicle 1, an inner wall 6B that is offset toward an inboard side relative to a lower end of the outer wall 6A in a stepped manner, and a connecting wall 6C that connects the lower end of the outer wall 6A and an upper end of the inner wall 6B, the garnish 7 includes an upper edge wall 7B provided along an upper edge of the plate-shaped portion 7A and arranged along the connecting wall 6C, and the upper end of the inner wall 6B is provided with a retainer 17 that locks the upper edge wall 7B.

According to this aspect, it is possible to reduce a gap between the upper end of the garnish 7 and the vehicle body panel 6 to reduce the penetration of water into the accommodating space 13.

In the above embodiment, preferably, the bracket 21 includes a support portion 21A arranged on an outboard side of the inner wall 6B with a gap therebetween, and a plurality of leg portions 21B extending from the support portion 21A to the inner wall 6B and fastened to the inner wall 6B, and the sensor (the radar 15) and the cover 22 are attached to the support portion 21A.

According to this aspect, since the sensor (the radar 15) is provided in the support portion 21A away from the vehicle body panel 6, even when water flows on the outer surface of the vehicle body panel 6 in the accommodating space 13, adhesion of water to the sensor (the radar 15) is suppressed.

In the above embodiment, preferably, the cover 22 includes a lower wall 32 extending from the bracket 21 to the garnish 7 below the sensor (the radar 15), and a pair of vertical walls 33 extending from the bracket 21 to the garnish 7 on lateral sides of the sensor (the radar 15), and an upper end of each of the vertical walls 33 is connected to the upper wall 31, and a lower end of each of the vertical walls 33 is connected to the lower wall 32.

According to this aspect, it is possible to suppress water splashed up from the road surface from adhering to the sensor (the radar 15).

In the above embodiment, preferably, a gap is formed between the lower wall 32 and the plate-shaped portion 7A.

According to this aspect, it is possible to prevent water from accumulating on the upper surface of the lower wall 32.

In the above embodiment, preferably, the upper wall 31 includes a base portion 31B extending from the bracket 21 to an outboard side, and an intermediate portion 31C bending upward from a distal end of the base portion 31B, the abutting portion 31A extends from an upper end of the intermediate portion 31C to the outboard side, and a thickness of the abutting portion 31A is thinner than a thickness of each of the base portion 31B and the intermediate portion 31C.

According to this aspect, it is possible to increase the flexibility of the abutting portion 31A higher than that of the base portion 31B and the intermediate portion 31C. Further, it is possible to increase the rigidity of the base portion 31B and the intermediate portion 31C, thereby suppressing deformation of the upper wall 31.

1. A vehicle body structure, comprising:
a vehicle body panel;
a garnish made of resin, attached to an outer surface of the vehicle body panel, and forming an accommodating space between the garnish and the vehicle body panel;
a bracket attached to the vehicle body panel in the accommodating space;
a sensor attached to the bracket; and
a cover attached to the bracket, wherein
the cover includes an upper wall extending laterally above the sensor and extending from the bracket to the garnish, and
the upper wall includes, at a distal end thereof, a plate-like abutting portion having flexibility and configured to bend and come into surface contact with an inner surface of the garnish.

2. The vehicle body structure according to claim 1, wherein the garnish includes a plate-shaped portion that is inclined downward toward the vehicle body panel, and
the abutting portion is inclined upward toward the plate-shaped portion and abuts against the plate-shaped portion.

3. The vehicle body structure according to claim 2, wherein an angle between the plate-shaped portion and the abutting portion is 30 degrees or more and 60 degrees or less.

4. The vehicle body structure according to claim 1, wherein the cover is made of an olefin-based thermoplastic elastomer.

5. The vehicle body structure according to claim 2, wherein the vehicle body panel includes an outer wall that forms an outer surface of a vehicle, an inner wall that is offset toward an inboard side relative to a lower end of the outer wall in a stepped manner, and a connecting wall that connects the lower end of the outer wall and an upper end of the inner wall,
the garnish includes an upper edge wall provided along an upper edge of the plate-shaped portion and arranged along the connecting wall, and
the upper end of the inner wall is provided with a retainer that locks the upper edge wall.

6. The vehicle body structure according to claim 5, wherein the bracket includes a support portion arranged on an outboard side of the inner wall with a gap therebetween, and a plurality of leg portions extending from the support portion to the inner wall and fastened to the inner wall, and
the sensor and the cover are attached to the support portion.

7. The vehicle body structure according to claim 6, wherein the cover includes a lower wall extending from the bracket to the garnish below the sensor, and a pair of vertical walls extending from the bracket to the garnish on lateral sides of the sensor, and
an upper end of each of the vertical walls is connected to the upper wall, and a lower end of each of the vertical walls is connected to the lower wall.

8. The vehicle body structure according to claim 7, wherein a gap is formed between the lower wall and the plate-shaped portion.

9. The vehicle body structure according to claim 1, wherein the upper wall includes a base portion extending from the bracket to an outboard side, and an intermediate portion bending upward from a distal end of the base portion,
the abutting portion extends from an upper end of the intermediate portion to the outboard side, and
a thickness of the abutting portion is thinner than a thickness of each of the base portion and the intermediate portion.

10. The vehicle body structure according to claim 1, wherein the sensor is a radar.
